(19) United States
(12) Patent Application Publication
(10) Pub. No.: US 2025/0236011 A1
(43) Pub. Date: Jul. 24, 2025

(54) ADJUSTABLE TOOL HOLDER FOR LIFT PLATFORM RAIL

(71) Applicant: Nicholas BRYANT, Shelbyville, IN (US)

(72) Inventor: Nicholas BRYANT, Shelbyville, IN (US)

(21) Appl. No.: 19/175,157

(22) Filed: Apr. 10, 2025

Related U.S. Application Data
(63) Continuation-in-part of application No. 18/367,255, filed on Sep. 12, 2023.
(63) Continuation-in-part of application No. 18/367,209, filed on Sep. 12, 2023.
(60) Provisional application No. 63/405,971, filed on Sep. 13, 2022.
(60) Provisional application No. 63/405,990, filed on Sep. 13, 2022.

(51) Int. Cl. B25H 5/00; F16B 2/14

(52) U.S. Cl. CPC B25H 5/00; F16B 2/14

(57) ABSTRACT

Tool holder mountable on guard rail of aerial lift platform includes a slidable wedge to minimize the gap between hook sides and the guard rail. This minimizes movement of the tool holder with respect to the guard rail when the platform is moved.

### FIELD OF THE INVENTION

The present invention relates to aerial platform lifts or aerial buckets whose height may be adjusted to facilitate working above ground, and in particular, to tool holders that may be mounted on aerial platforms.

### BACKGROUND

Workers such as electricians on aerial platform lifts (or buckets) need to access and use various tools and supplies during a job. Such lifts generally have guard rails from which tools or holders may be mounted or hung. However, such tools and holders are often configured to fit only the guard rails of a specific platform or must be affixed to the platform with screws or fasteners that alter the physical integrity of the platform. Those types of tools and holders cannot be used with platforms that are rented, as is usually the case, because alteration of a rented platform is prohibited by the rental agreement. Moreover, a tool holder that works for one brand or model of lift may not fit or hold tools for other brands or models. Before a worker shows up at a job site to use an aerial lift, the worker may not know what brand or model of aerial lift will be available. Thus, it is desirable to provide tools and holders that can fit on various aerial lifts of different manufacturers and models, and that do not require altering the physical integrity of the platform.

In addition, such aerial lifts and platforms are usually movable, both vertically and horizontally, while the worker is in them. Moving the lift tends to loosen or dislodge any tools or tool holders that may be supported by the guard rail of the lift. This can cause the tools or tool holders to inadvertently fall from lift and cause grievous injury to persons below the platform.

### BRIEF DESCRIPTION OF THE DRAWINGS

FIG. 1 is a perspective view of a slidable wedge for use in connection with a tool holder.

FIG. 2 is a front view of the slidable wedge of FIG. 1.

FIG. 3 is an end view of the slidable wedge of FIGS. 1 and 2.

FIG. 4 is a side view of the slidable wedge of FIGS. 1-3.

FIG. 5 is a side view showing a conduit and spool holding system having two slidable wedges.

FIG. 6 is a side close-up view of the conduit and spool holding system of FIG. 5 showing the top slidable wedge.

FIG. 7 is a side close-up view of a conduit and spool holding system of FIG. 5 showing the bottom slidable wedge.

FIG. 8 is a perspective view of a universal tool holding system for a lift platform having a notch that receives a specific tool holding system having that flange, namely a handle holder.

FIG. 9 is a side cross sectional view of the universal tool holding system shown in FIG. 8 with a wedge positioned to hold the system to a guard rail.

FIG. 10 is a perspective view of a tool holder for holding a cup.

FIG. 11 is a perspective view of a sheet caddy having a tether to attached to a slidable wedge, and

FIG. 12 is a side cross sectional view of the sheet caddy shown in FIG. 11 with a wedge positioned to hold the caddy against a guard rail.

FIG. 13 is a side view of a universal tool holding system for a lift platform having a detachable member sized to engage a guard rail of a predefined width.

FIG. 14 shows various types of aerial lifts or platforms having guard rails.

### DETAILED DESCRIPTION

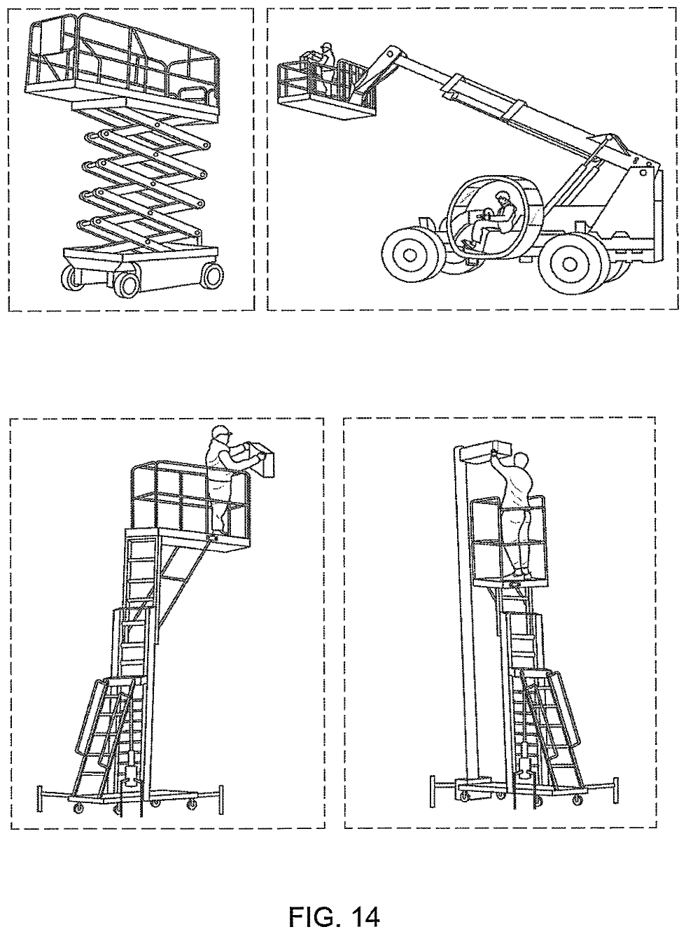

As shown in FIG. 14, lift platforms or aerial lifts may be mounted to a mechanism for adjusting the height of the lift platform from the ground while a person is on the lift platform. Such mechanisms include scissors lifts, areal booms, extendable ladders and scaffolding. The platforms include guard rails to help prevent a worker from falling from the platform.

Tool holders, such as a tool caddy, conduit bender holder or cable and conduit holder disclosed in the applications from which this application claims priority, may be mounted on guard rails of aerial lifts. However, such holders may not securely fit unless the guard rail engaging surfaces of a holder matches the width of the guard rail on which it is mounted. If mounting hooks of a tool holder are made so wide that it will fit on the widest guard rail of any lift, then it be loose when mounted on a guard rail that is not as wide. Accordingly, a wedge may be slidably affixed to a holder body proximate to where the holder will engage the guard rail. The wedge may be slid along the holder body so it is between the holder body and the guard rail. This limits the extent to which the tool holder may shift with respect to the guard rail and aerial lift, reducing the risk that tools or workpieces shifting, especially when the aerial lift is moved.

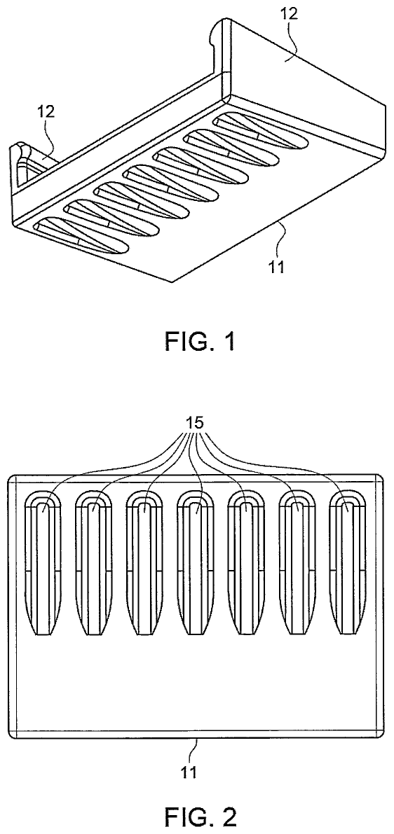

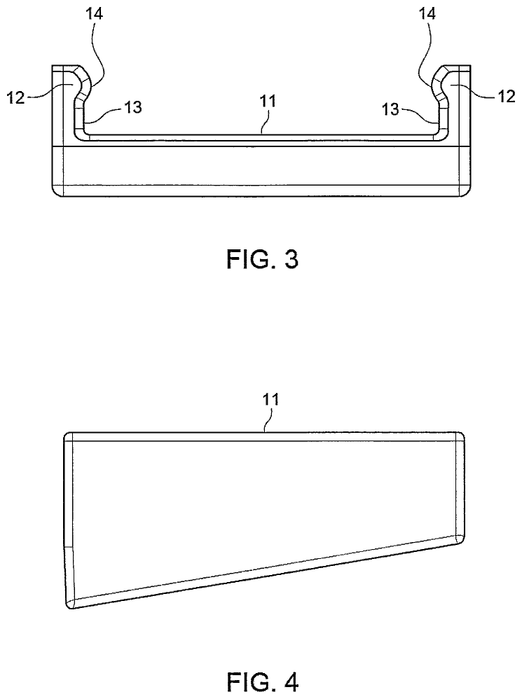

FIGS. 1-4 show wedge 11 which may have a generally trapezoidal shape when viewed from the side, and an opposing pair of pair for of arms 12, each having a recess 13 bounded by inwardly projecting portions 14. Grooves may formed in the face of wedge.

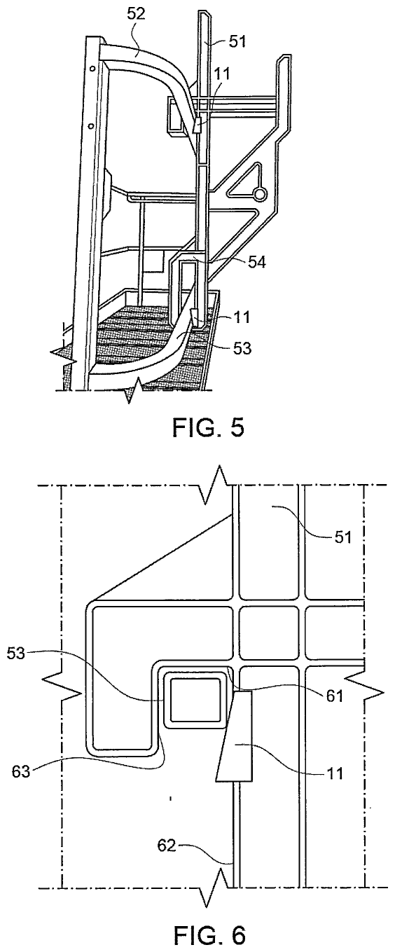

As shown in FIG. 5, wedges 11 may be positioned on holder body 51 which is supported by guard rail 52 of a lift platform. The representative holder body 51 may of any desired design, and the version shown as 51 is a spool and conduit holding system as described in U.S. non-provisional application Ser. No. 18/367,209. As shown in FIG. 6, holder body includes an upper rail engaging surface 61 that engages upper rail 52, a first surface 62 downwardly extending from the rail engaging surface and a second surface 63 downwardly extending from the rail engaging surface. The second surface 63 is substantially parallel to the first surface 62. Wedge 11 has arms that are pliable enough to be slightly spread so that they can fit over the first surface 62 and second surface 63 of holder body 51, and slide along those surfaces. The upper, first and second surfaces 61, 62 and 63 of holder body is placed over and hangs from guard rail 52. Wedge 11 may slide upward along holder body until it engages guard rail 52. This configuration reduces shifting of holder body 51 on guard rail 52, and allows the holder body 51 to be used on lifts having different widths of guard rail and cross sections shapes.

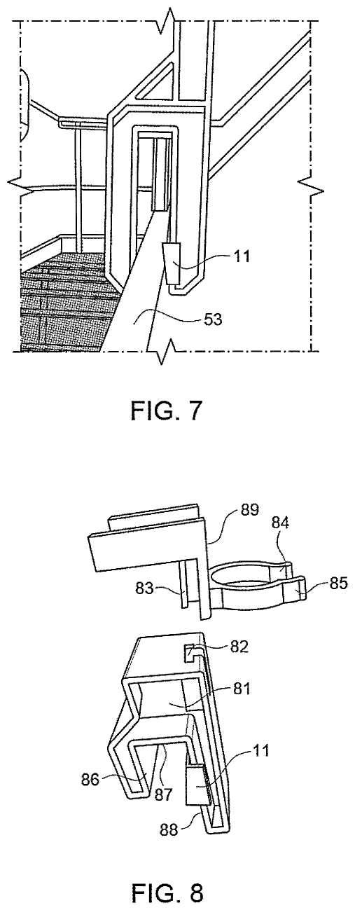

As shown in FIGS. 5 and 7, holder 51 may also have a lower hook 54 configured to fit over lower guard rail 52. The lower hook may also have on one prong slidable wedge 11. In this configuration, wedge 11 is initially positioned toward the top of hook 54, and the hook is positioned so its arms are between lower guard rail 52. Wedge is then slid downward until it fills the gap between the prongs of hook 54 and lower guard rail 52.

FIG. 8 is a perspective view of a universal tool holding system for a lift platform. Holder 81 includes notch 82 that may receive different types of tool holders that have a mating flange 83 sized to be inserted in to notch 82 to hold tool holder 89.

The version of tool holder 89 shown in FIG. 8, at least two resilient extending arms 84, 85 include inwardly facing arcuate surfaces operable to clasp the handle of a tool, such as a conduit bender. Another representative tool holder that may be held by holder 81 is cup holder 101 shown in FIG. 10. Cup holder 101 includes flange 102 which also is sized to be slid into notch 82 of holder 81.

Holder 81 includes an upper rail engaging surface 87 that engages upper rail 52, a first surface 88 downwardly extending from the rail engaging surface and a second surface 86. It may also include a wedge 11 that slides on second surface 86 to secure holder 81 to a guard rail as described above.

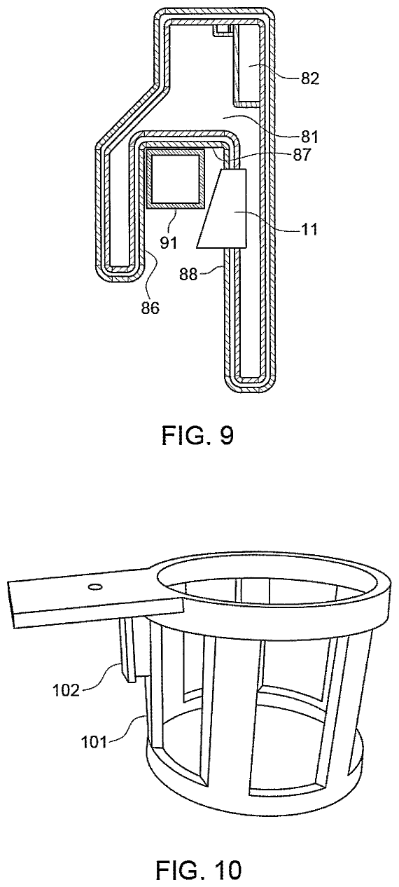

FIG. 9 is a side cross sectional view of the universal tool holding system shown in FIG. 8. The space between first surface 88, second surface 86 and upper rail engaging surface 87 may be positioned over upper guard rail 91. Wedge 11 may be slid up on first surface 88 to secure the holding system thereto.

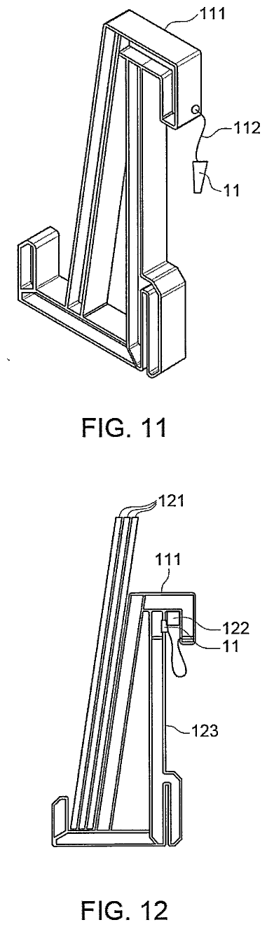

FIG. 11 is a perspective view of a holder comprising a sheet caddy 111 having a tether 112 to attached to a slidable wedge 11. FIG. 12 is a side cross sectional view of the sheet caddy shown in FIG. 11 with a wedge 11 positioned to hold the caddy against a guard rail 122. Sheet caddy 111 can hold multiple sheets 121, such as drywall sheets or plywood sheets. Because the opposing sides of wedge 11 may be pliable, wedge 11 may be affixed to or removed from
surface 123 as needed. A tether 112 may connect wedge 111 to holder/sheet caddy 111 so the wedge is not misplaced or lost.

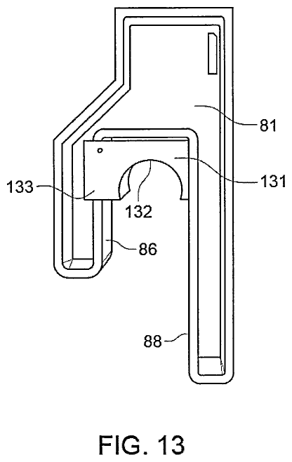

FIG. 13 is a side view of a universal tool holding system for a lift platform having a detachable member sized to engage a guard rail of a predefined width. In contrast to the use of wedge, holder 81 may receive a removable guard rail adaptor 131. Adaptor may have a concave surface 132 that is less than the distance between opposing side surface 86, 88, and sized to engage the contour of an upper guard rail. Resilient arms 133 may be on either side of rail adaptor 131 to allow it attach to holder 81 as described above. A variety of adaptors may be provided having concave surfaces sized to match the shapes of different upper guard rails of various lift platforms.

The holders described herein to does not require screws or other attachment devices to be secured to the lift platform, so they do not mar the finished surface of the lift platform. The holder can easily be removed from one area on a lift platform guard rail to another area on the guard rail, or from one lift platform and moved to a different lift platform. These features are important because many contractors rent lift platforms, as opposed to owning them, so the contractors are not allowed to permanently attach fixtures to rented lift platforms and must return them in an unblemished condition.

The systems described herein help keep the floor of the lift platform free of clutter and allows a worker to reach and manipulate workpieces without excessive bending as compared to storing these items on the floor of the lift platform.

While the invention has been illustrated and described in detail in the foregoing drawings and description, the same is to be considered as illustrative and not restrictive in character, it being understood that only illustrative embodiments thereof have been show and described and that all changes and modifications that are within the scope of the following claims are desired to be protected.

All references cited in this specification are incorporated herein by reference to the extent that they supplement, explain, provide a background for or teach methodology or techniques employed herein.

1. A tool holder mountable on a first guard rail of a lift platform mounted to a mechanism for adjusting the height of the lift platform from the ground while a person is on the lift platform comprising:
a holder body adapted to hold a tool comprising
an upper rail engaging surface
a first surface downwardly extending from the rail engaging surface;
a second surface downwardly extending from the rail engaging surface, the second surface being substantially parallel to the first surface;
such that the rail engaging surface, first surface and second surface may be placed over the guard rail of the lift platform;
a slidable wedge mounted on the first surface such that it may be slid along the first surface toward and away from the rail engaging surface, the slidable wedge being operable to engage a guard rail abutting the rail engaging surface, the second surface and the wedge to thereby limit movement of the holder body with respect to the guard rail.

2. The tool holder of claim 1 wherein the wedge comprises a plurality of grooves.

3. The tool holder of claim 1 wherein the first surface has side edges and the wedge comprises first and second arms, each such arm having a recess that fits around a side edge of the first surface to slidably secure the wedge to the first surface.

4. The tool holder of claim 1 wherein the tool holder further comprises a vertically extending notch into which a flanged second tool holder may be inserted so that the second tool holder is held by the tool holder.

5. The tool holder of claim 4 further comprising:
a second tool holder comprising a flange that is insertable into the notch of the tool holder.

6. The tool holder of claim 5 wherein the second tool holder comprises at least two resilient extending arms defining inwardly facing arcuate surfaces operable to clasp the handle of a conduit bender.

7. The tool holder of claim 1 wherein:
the lift platform further comprises a second guardrail beneath the first guard rail,
and wherein the holder body further comprises:
a plurality of stabilizing bars projecting from the holder body, each a hook positionable over a lower guard rail;
two upwardly projecting arms defining a space therebetween sufficient to allow placement of a plurality of conduits such that the holder body and conduits are supported by the guard rail.

8. The tool holder of claim 4 further comprising:
a second tool holder comprising a flange that is insertable into the notch of the tool holder.

9. A tool holding system mountable on a first guard rail of a lift platform mounted to a mechanism for adjusting the height of the lift platform from the ground while a person is on the lift platform comprising:
a holder body comprising:
an upper rail engaging surface
a first surface downwardly extending from the rail engaging surface;
a second surface downwardly extending from the rail engaging surface, the second surface being substantially parallel to the first surface;
such that the rail engaging surface, first surface and second surface may be placed over the guard rail of the lift platform;
a vertically extending notch into which a flanged tool holder may be inserted so that the flange of the tool holder is held by the holder body.

10. The holding system of claim 9 wherein the tool holder further comprises at least two resilient extending arms defining inwardly facing arcuate surfaces operable to clasp the handle of a conduit bender.

11. The holding system of claim 9 wherein the tool holder further comprises a cup holder.
